(19) United States
(12) Patent Application Publication
(10) Pub. No.: US 2024/0217198 A1
(43) Pub. Date: Jul. 4, 2024

(54) MANUFACTURING TECHNIQUES AND PROCESSES FOR A TUBULAR MEMBER

(71) Applicant: TrikaUSA Inc., Superior, WI (US)

(72) Inventors: Larry Pulkrabek, Superior, WI (US); Jake Carse, Superior, WI (US); Ron Hedberg, Superior, WI (US)

(21) Appl. No.: 18/399,308

(22) Filed: Dec. 28, 2023

Related U.S. Application Data
(60) Provisional application No. 63/436,325, filed on Dec. 30, 2022.

(51) Int. Cl. B32B 1/08; B32B 3/02; B32B 5/12; B32B 7/022; B32B 37/10

(52) U.S. Cl. CPC B32B 1/08; B32B 3/02; B32B 5/12; B32B 7/022; B32B 37/10; B32B 2250/03; B32B 2307/518; B32B 2307/54; B32B 2307/737

(57) ABSTRACT

A method of manufacturing a tubular member includes stacking a plurality of materials on a rolling table and rolling the plurality of materials around a mandrel to form the tubular member. The plurality of materials include one or more bottom layers and an upper layer stacked on top of the one or more bottom layers. The upper layer comprises a fibrous material including (a) a first plurality of fibers that extend in a positive direction relative to a lengthwise direction of the upper layer and (b) a second plurality of fibers that extend in a negative direction relative to the lengthwise direction of the upper layer. The first plurality of fibers and the second plurality of fibers form an X-pattern.

### CROSS-REFERENCE TO RELATED PATENT APPLICATION

This application claims the benefit and priority to U.S. Provisional Patent Application No. 63/436,325, filed Dec. 30, 2022, which is incorporated herein by reference in its entirety.

### BACKGROUND

The present disclosure relates generally to manufacturing tubular members. More particularly, the present disclosure relates to manufacturing tubular members using a rolling technique.

### SUMMARY

One embodiment relates to a method of manufacturing a tubular member. The method includes stacking a plurality of materials on a rolling table and rolling the plurality of materials around a mandrel to form the tubular member. The plurality of materials include one or more bottom layers and an upper layer stacked on top of the one or more bottom layers. The upper layer comprises a fibrous material including (a) a first plurality of fibers that extend in a positive direction relative to a lengthwise direction of the upper layer and (b) a second plurality of fibers that extend in a negative direction relative to the lengthwise direction of the upper layer. The first plurality of fibers and the second plurality of fibers form an X-pattern.

Another embodiment relates to a tubular member. The tubular member includes a tubular member having a sidewall including with a plurality of layers comprising a plurality of differing materials. A first material of the plurality of differing materials includes (a) a first plurality of fibers that extend helically through the sidewall along a length of the tubular member in a positive direction and (b) a second plurality of fibers that extend helically through the sidewall along the length of the tubular member in a negative direction.

Another embodiment relates to a method of manufacturing a tubular member. The method includes providing a first sheet of a first material, providing a second sheet of a second material, providing a third sheet of a third material, stacking the first sheet, the second sheet, and the third sheet on a rolling table, and rolling the first sheet, the second sheet, and the third sheet around a mandrel to form the tubular member. The first sheet has a first shape. The first sheet has a first material property. The second sheet has a second shape different than the first shape. The second material has a second material property different than the first material property. The third sheet has a third shape different than the first shape and the second shape. The third material has a third material property different than the first material property and the second material property.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a first view of a mandrel in a rolling table assembly for rolling a stack of materials into a tubular member, according to some embodiments.

FIG. 2 is a second view of the mandrel in the rolling table of FIG. 1 from an opposite end, according to some embodiments.

FIG. 3 is a view of the mandrel of FIGS. 1-2, according to some embodiments.

FIG. 4 is a perspective view of the mandrel of FIGS. 1-3, according to some embodiments.

FIG. 5 is a diagram of the rolling table assembly of FIG. 1 including different pressure zones, according to some embodiments.

FIG. 6 is a perspective view of the stack of materials of FIG. 1 rolled into a tubular member, according to some embodiments.

FIG. 7 is a side view of the stack of materials of FIG. 1, according to some embodiments.

FIG. 8 is a top view of a first layer of the stack of materials of FIG. 7, according to some embodiments.

FIG. 9 is a top view of the first layer and a second layer of the stack of materials of FIG. 7, according to some embodiments.

FIG. 10 is a top view of the first layer, the second layer, and a third layer of the stack of materials of FIG. 7, according to some embodiments.

FIG. 11 is a view from a first end of the mandrel of FIG. 1 after performing a first roll of the stack of materials of FIG. 7 onto the mandrel, according to some embodiments.

FIG. 12 is a view from the first end of the mandrel of FIG. 1 after performing a second roll of the stack of materials of FIG. 7 onto the mandrel, according to some embodiments.

FIG. 13 is a view from the first end of the mandrel of FIG. 1 after finishing a third roll of the stack of the stack of materials of FIG. 7 onto the mandrel, according to some embodiments.

FIG. 14 is a perspective view of the first material and the second material of FIG. 7 stacked on a rolling table, according to some embodiments.

FIG. 15 is a perspective view of the first material, the second material, and the third material of FIG. 7 stacked on the rolling table, according to some embodiments.

FIG. 16 is a perspective view of rolling the stack of materials of FIG. 7, according to some embodiments.

FIG. 17 is a diagram of fibers of the first material of FIG. 7, according to some embodiments.

FIG. 18 is a diagram of fibers of the second material of FIG. 7, according to some embodiments.

FIG. 19 is a diagram of fibers of the third material of FIG. 7, according to some embodiments.

FIG. 20 is a flow diagram of a process for stacking and rolling a stack of materials to produce a tubular member, according to some embodiments.

FIG. 21 is a perspective view illustrating fibers of the third material of FIG. 7 extending in a bi-directional helical pattern, according to some embodiments.

### DETAILED DESCRIPTION

Before turning to the Figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

According to an exemplary embodiment, a plurality of composite materials can be stacked and rolled around a mandrel into a tubular member. The composite materials may include a first sheet of material, a second sheet of material, and a third sheet of material. The first sheet of material and second sheet of material may include longitudinally extending fibers and have different moduli. The third sheet of material includes arrays of fibers arranged in an X-pattern or a cross pattern. When the materials are rolled into the tubular member, the X-patterns of fibers extend helically along the length of the tubular member in opposite spiral directions.

### Rolling Table System

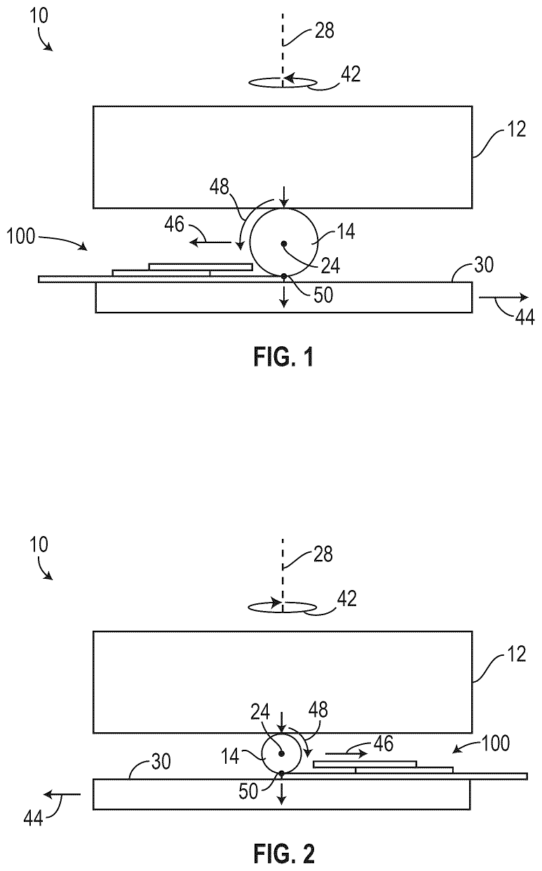

Referring to FIGS. 1-2, a rolling table 10 (e.g., a rolling system, a rolling apparatus, a roller, a rolling assembly, a manufacturing assembly, etc.) includes a first member 12 (e.g., a block, a structural member, a translatable plate, a rotatable and translatable plate, a biasing member, an engagement member, etc.), a second member 30 (e.g., a table, a surface member, a structural member, a translatably stationary plate, a rotatable plate, a table top, a counter top, a work surface, etc.), and a mandrel 14 (e.g., an elongated member, a cylindrical member, a tapered member, a tapered cylindrical member, an elongated frustoconical member, etc.). The first member 12 and the second member 30 are configured to translate relative to each other along a vertical axis 28 such that the first member 12 and the second member 30 sandwich the mandrel 14, engage the mandrel 14 on both sides, and directly engage or contact the mandrel 14 on at least one side (e.g., on a top side or a bottom side). In some embodiments, translation of the first member 12 and the second member 30 relative to each other in order to decrease or increase a distance between the first member 12 and the second member 30 along the vertical axis 28 is achieved by driving translation of the first member 12 relative to the second member 30, by driving translation of the second member 30 relative to the first member 12, or by driving translation of both the first member 12 and the second member 30 to generate a compressive force for rolling a stack of materials.

In some embodiments, the second member 30 is configured to translate (e.g., by operation of an actuator, a cylinder, a hydraulic or pneumatic cylinder, an electric motor or actuator, etc.) in a lateral direction 44. Translation of the second member 30 in the lateral direction 44 causes relative translation between the mandrel 14 and the second member 30 in an opposite lateral direction 46. In some embodiments, a stack of materials 100 (e.g., a stack of sheets, a stack of composite materials, a stack of carbon fibers, flags, etc.) are positioned proximate or next to the mandrel 14 further in the opposite lateral direction 46. As the second member 30 is driven to translate in the lateral direction 44, the mandrel 14 is driven to rotate relative to the second member 30 in a direction 48. The mandrel 14 may be driven to rotate over the stack of materials 100 to roll the stack of materials 100 around the mandrel 14 to thereby produce a tubular member having an inner form that matches or corresponds to the outer shape of the mandrel 14. As shown in FIG. 1, the mandrel 14 is driven by translation of the second member 30 and engagement by the second member 30 and the first member 12 so that the mandrel 14 rolls over the stack of materials 100 while exerting a compressive force onto the stack of materials 100 between a contact point 50 and the second member 30.

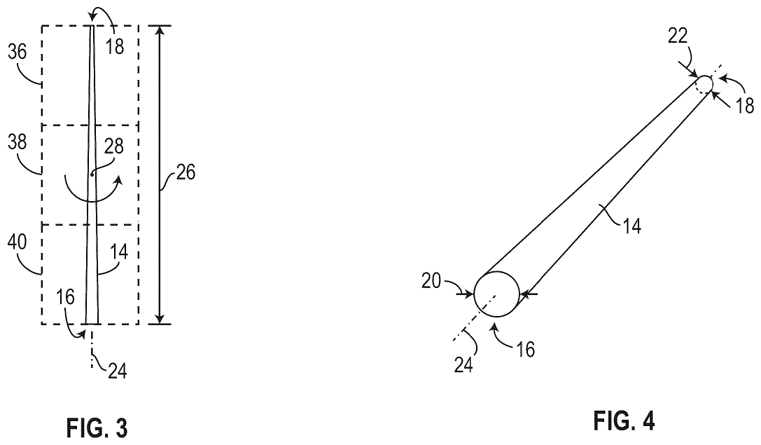

Referring to FIGS. 3 and 4, the mandrel 14 may have a tapered shape or a decreasing, variable, or changing diameter along the length of the mandrel 14. The shape, size, and geometry of the mandrel 14 can be adjusted in order to produce a tubular member having a desired shape and size. As shown in FIG. 4, the mandrel 14 defines a longitudinal axis 24 that extend lengthwise through a center of the mandrel 14. The mandrel 14 may rotate about the longitudinal axis 24 when rolling the stack of materials 100 to produce a tubular member (e.g., a hollow elongated member, a tube, a pipe, a rod, etc.). The mandrel 14 may have a first end 16 and a second end 18. In some embodiments, a diameter of the mandrel 14 decreases continuously (e.g., linearly) along the length of the mandrel 14 from the first end 16 to the second end 18. In some embodiments, the mandrel 14 has a diameter 20 at the first end 16 that is greater than a diameter 22 at the second end 18. In some embodiments, the mandrel 14 decreases in diameter along the length of the mandrel 14 in a discrete or stepped manner (e.g., between different sections). The mandrel 14 can be designed in such a manner to have dimensions, shape, changing dimensions along the length of the mandrel 14, etc., as desired. The mandrel 14 may determine a geometry of the resulting tubular member produced by rolling the stack of materials 100 around the mandrel 14.

Referring to FIG. 3, the mandrel 14 can have a length 26 that is substantially equal to a desired length of the resulting tubular member that is produced by rolling the stack of materials 100 around the mandrel 14. In some embodiments, the length 26 of the mandrel is greater than the desired length of the resulting tubular member such that ends of the tubular member can be trimmed. In some embodiments, the mandrel 14 includes a first portion 36 (e.g., a narrow portion, an end portion, etc.), a second portion 38 (e.g., a middle portion, a medial portion, etc.), and a third portion 40 (e.g., a thicker portion, an opposite end portion, etc.). In some embodiments, the mandrel 14 may be rolled over the stack of materials 100 with different pressures or forces applied along the length 26 of the mandrel 14 (e.g., differing pressures or forces at the first portion 36, the second portion 38, and the third portion 40). FIG. 1 shows a view from the first end 16 when the mandrel 14 is installed on the rolling table 10, while FIG. 2 shows a view from the second end 18 when the mandrel 14 is installed in the rolling table 10.

Referring again to FIG. 1, the first member 12 may be configured to rotate about the vertical axis 28 in a direction 42 as the second member 30 rotates in the lateral direction 44. Due to the tapering or the general frustoconical shape of the mandrel 14, the second end 18 may rotate faster than the first end 16, which results in rotation of the mandrel 14 about the vertical axis 28 or an axis parallel with the vertical axis 28. The first member 12 may rotate about the vertical axis 28 to compensate for the rotation of the mandrel 14. In this way, the materials 100 can be tightly and uniformly wound onto the mandrel 14.

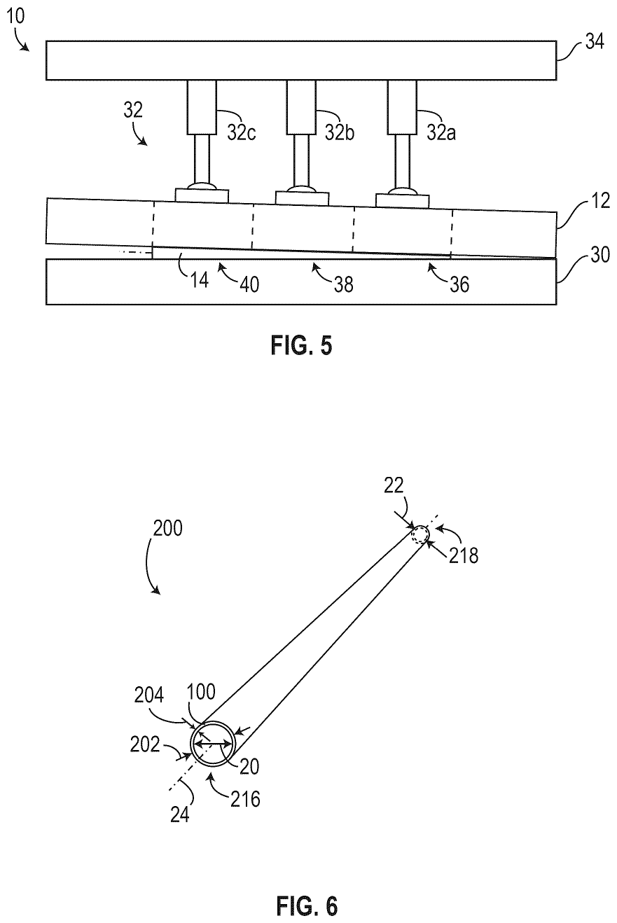

Referring to FIG. 5, the first member 12 may be driven to translate to engage or exert a compressive force on the mandrel 14 by actuators 32. In some embodiments, the rolling table 10 includes a first actuator 32a that is configured to exert a first amount of force or pressure on the mandrel 14 along the first portion 36, a second actuator 32b that is configured to exert a second amount of force or pressure on the mandrel 14 along the second portion 38, and a third actuator 32c that is configured to exert a third amount of force or pressure on the mandrel 14 along the third portion 40. In this way, the actuators 32 may exert different amounts of force or pressure along the mandrel 14 while the stack of materials 100 are rolled around the mandrel 14 to reduce voids in the stack of materials 100, reduce fibers or layers of the materials 100 from rolling off the mandrel 14, and to maximize strength and performance of a resulting tubular member 200 that is produced by rolling the stack of materials 100.

It should be understood that the techniques used to roll the materials 100 onto the mandrel 14 as described herein with reference to FIGS. 1-2 and 5 are illustrative only and should not be understood as limiting. Various techniques such as rolling by hand, rolling between multiple rollers, using a modified rolling table, etc., can be performed in order to roll the materials 100 onto the mandrel 14.

Referring to FIG. 6, the stack of materials 100 may be rolled to result in the tubular member 200. The tubular member 200 includes the stack of materials 100 forming walls (e.g., sidewalls, boundaries, peripheries, inner and outer surfaces, etc.) of the tubular member 200. The tubular member 200 may be hollow once the mandrel 14 is removed (e.g., before or after curing of epoxy that is distributed between the layers of the materials 100). The tubular member 200 has an inner diameter that is substantially the same as diameter 20 at a first end 216, and diameter 22 at a second end 218. The tubular member 200 has an outer diameter 202 that is substantially equal to the inner diameter at a current location along the tubular member 200 plus a wall thickness 204. In some embodiments, the wall thickness 204 is substantially equal to a total thickness or height of the stack of materials 100 multiplied by a factor of a number of rolls or revolutions that are completed with the mandrel 14.

### Material Stack

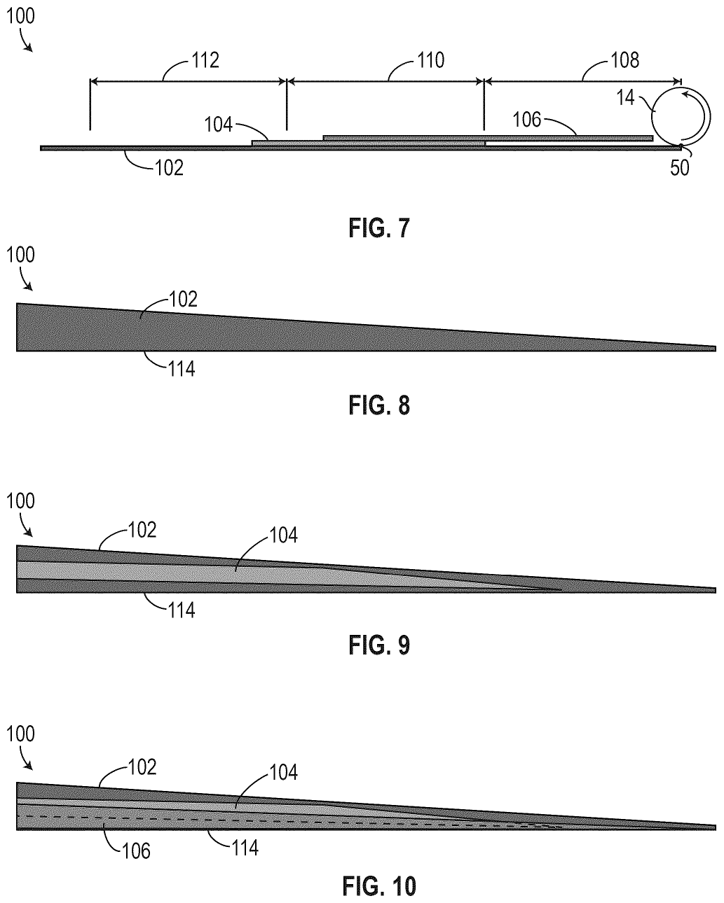

Referring to FIG. 7, the stack of materials 100 is shown from a side view. The stack of materials 100 includes multiple sheets of various materials (e.g., composites, metals, plastics, etc.) stacked in a specific arrangement. In an exemplary embodiment, the materials are composite materials, and one or more of the materials are a woven material (e.g., fabric, a carbon fabric, etc.) The stack of materials 100 includes a first material 102 that is disposed as a bottom layer of the materials 100, a second material 104 that is a middle or sandwiched layer of the materials 100, and a third material 106 (e.g., an integrated X-weave material with fibers in an X-pattern or cross-pattern) that is an upper or top layer of the materials 100. The stack of materials 100 is scrimless and does not include any scrim (e.g., a thin tissue-like paper or material) between the materials 100 (e.g., a carbon scrim, a fiberglass scrim, etc.). In some embodiments, the stack of materials 100 includes thin layers of epoxy or resin between the materials 100. In some embodiments, the materials 100 are provided as sheets (e.g., thin sheets) that can be cut to a desired shape and stacked as shown in FIG. 7.

The first material 102 is positioned on the bottom so that, when the materials 100 are rolled into the tubular member 200, the first material 102 forms or defines an outer surface of the tubular member 200. The first material 102 can include tacky edges that facilitate binding and rolling of the materials 100 onto the mandrel 14. FIG. 7 illustrates a first distance 108 that corresponds to a first complete roll of the mandrel 14 (e.g., a circumference of the mandrel 14), a second distance 110 that corresponds to a second complete roll of the mandrel 14, and a third distance 112 that corresponds to a third complete roll of the mandrel 14. The mandrel 14 is shown contacting the first material 102 at the contact point 50, which marks the beginning of the first roll of the mandrel 14. Once the mandrel 14 is rotated to roll the materials 100 across the first distance 108 (e.g., the first complete roll), the contact point 50 of the mandrel 14 is at the transition between the first distance 108 and the second distance 110. Similarly, once the mandrel 14 is rotated to roll the materials across the second distance 110 (e.g., the second complete roll), the contact point 50 of the mandrel 14 is at the transition between the second distance 110 and the third distance 112. Once the mandrel 14 is rotated to roll the materials 100 across the third distance 112 (e.g., the third complete roll), the contact point 50 of the mandrel 14 may be at the end of the third distance 112 opposite the transition between the second distance 110 and the third distance 112. In some embodiments, the mandrel 14 is driven to complete a fourth complete roll in order to take up or roll any additional materials 100 that extend beyond the end of the third distance 112 and to press the rolled materials 100 onto each other.

As shown in FIG. 7, the first material 102 extends from a beginning of the first distance 108, and extends past the end of the third distance 112. In this way, the first material 102 may form the outer surface of the tubular member 200 and provide an outermost barrier for the tubular member 200. The first material 102 may have a modulus (e.g., a tensile modulus) that is less than a modulus of the second material 104. In some embodiments, the first material 102 may have a modulus (e.g., a tensile modulus) that is less than the modulus of the second material 104 but greater than a modulus of the third material 106. In some embodiments, the first material 102 is or includes a carbon material or composite material having a twist fiber.

As shown in FIG. 7, the third material 106 begins at a point within the first distance 108 (e.g., along the first complete roll of the mandrel 14). The third material 106 may begin at substantially a beginning of the first roll (e.g., at the beginning of the first distance 108) or may begin at a position past the beginning of the first roll but before a middle of the first roll. In some embodiments, the third material 106 extends through a portion of the second roll, and terminates at a position beyond a middle point of the second roll. In some embodiments, the third material 106 extends to the transition between the second roll (e.g., the second distance 110) and the third roll (e.g., the third distance 112). In some embodiments, FIG. 7 illustrates a stack up of the materials 100 at the first end 216 of the tubular member 200. At the second end 218 of the tubular member 200, the stack up of the materials 100 may include only the first material 102 and the third material 106. In some embodiments, only the third material 106 and the first material 102 are along the first distance 108 (e.g., the first roll) and at least one roll length of the first material 102 extends beyond a terminating point of the second material 104.

In some embodiments, the third material 106 is a composite material that includes fibers in an X-pattern along the length of the mandrel 14. For example, the third material 106 can include an X-weave or cross-weave pattern of fibers. In some embodiments, the third material 106 begins at a point after a beginning of the first material 102 (it should be understood that “beginning” and “ending” of the materials described herein is with reference to the beginning contact point 50 of the mandrel 14 for rolling e.g., from right to left) and terminates or ends at a point past the beginning of the second material 104 but before an end of the second material 104. In some embodiments, the third material 106 terminates at least an entire roll distance before an end of the first material 102 (e.g., where “roll distance” is substantially equal to a circumference of the mandrel 14 at a current location along the mandrel 14).

Referring still to FIG. 7, the second material 104 begins at the beginning of the second roll (e.g., the beginning of the second distance 110, the transition between the first distance 108 and the second distance 110, the end of the first distance 108) and terminates or ends at a position past the end of the second distance 110 (e.g., at a position past a beginning of the second roll). In some embodiments, the second material 104 is sandwiched between the first material 102 and the third material 106. In some embodiments, the second material 104 is sandwiched (e.g., directly contacted on opposite sides) by the first material 102 and the third material 106 along a portion of the second roll of the mandrel 14 (e.g., from a beginning of the second roll to a position past a middle of the second roll). The second material 104 may have a high modulus (e.g., a tensile modulus). In some embodiments, the second material 104 has a higher modulus (e.g., tensile modulus) than the first material 102.

Referring to FIG. 8-10, the stack of materials 100 can be arranged by first placing the first material 102 on the second member 30 as shown in FIG. 8. The first material 102 may be a thin sheet that has the form of a right trapezoid, with the two right angles being positioned at the first end 16 and the second end 18 of the mandrel 14. In some embodiments, rolling of the materials 100 begins at a side or edge 114 that partially defines both of the two right angles. In some embodiments, the first material 100 has another quadrilateral shape, or a triangular shape. A width of the first material 100 generally decreases from the first end 16 of the mandrel 14 to the second end 18 of the mandrel 14 (e.g., from left to right as shown in FIG. 8) in order to match the corresponding decrease in diameter, radius, and circumference of the mandrel 14 from the first end 16 to the second end 18.

Referring to FIG. 9, the second material 104 may next be placed or stacked on top of the first material 102. The second material 104 can be placed on the first material 102 such that, at the first end 16 of the mandrel 14, the second material 104 is spaced the distance 108 from the edge 114. The second material 104 can have the form of another right trapezoid, with the side that partially defines the two right angles being positioned along the edge of the first material 102 that is perpendicular to the edge 114 and proximate the first end 16 of the mandrel 14. Referring to FIG. 10, the third material 106 is next stacked or placed on top of the second material 104. The third material 106 may have the shape of a right triangle that extends from one end of the first material 102 to an end of the first material 102.

### Materials and Fiber Directions

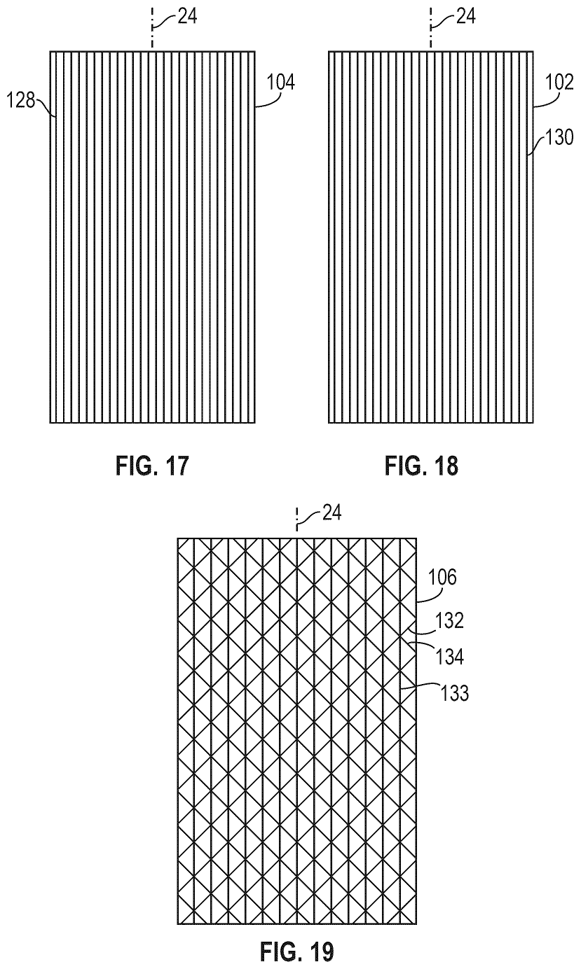

Referring to FIGS. 17-19, the first material 102 and the second material 104 can include fibers that extend longitudinally and/or parallel with each other. The first material 102 includes fibers 130 that extend longitudinally (e.g., parallel with the axis 24 or lengthwise along a length of the materials 100). The second material 104 similarly includes fibers 128 that extend longitudinally (e.g., parallel with the axis 24 or lengthwise along a length of the materials 100). The third material 106 includes fibers 132 that extend at a first 45 degree angle, and fibers 134 that extend at a second 45 degree angle (e.g., perpendicular with the fibers 132) thereby producing an X-weave, an X-pattern, a cross-weave, or a cross-pattern. In some embodiments, the fibers 132 and the fibers 134 are 45 degrees relative to the axis 24 or relative to the length of the materials. The third material 106 may be a fabric that includes cross-pattern or X-pattern fibers. In some embodiments, the fibers 132 and 134 are perpendicular with each other but are angled other than 45 degrees relative to the lengthwise direction of the materials 100. The third material 106 can also include multiple longitudinally extending fibers 133 (e.g., at 0 degrees relative to the axis 24) to provide structural stability for the fibers 132 and the fibers 134. The third material 106 can be produced by placing the fibers 132 and the fibers 134 onto the fibers 133. The third material 106 results in cross-biasing a resulting tubular member in multiple directions which improves flexural strength of the resulting tubular member.

### Tubular Member

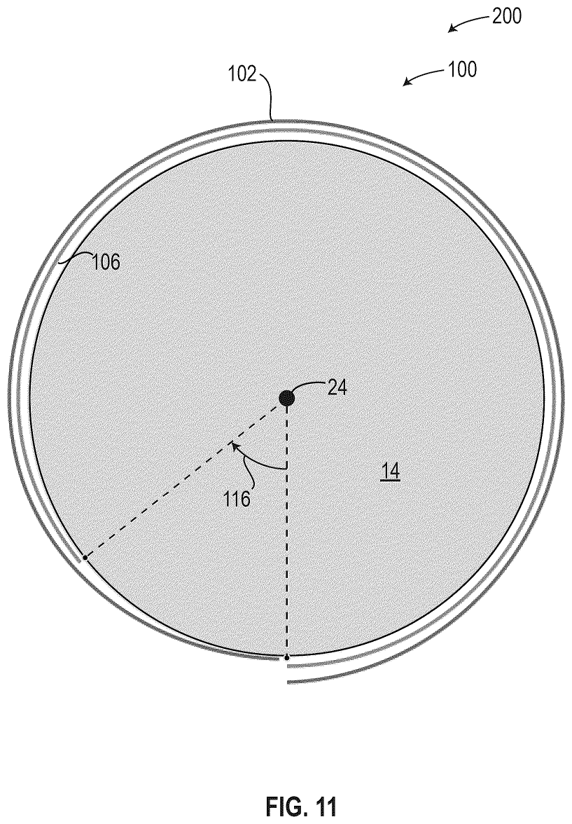

FIG. 11 illustrates a view from the first end 16 of the mandrel 14 after performing the first roll across the distance 108. When the first roll is performed, an angular portion 116 of the tubular member 200 that is being performed by the roll includes only the first material 102. The rest of the angular portions of the tubular member 200 beyond the angular portion 116 include both the third material 106 and the first material 102, with the third material 106 being positioned within the third material 102.

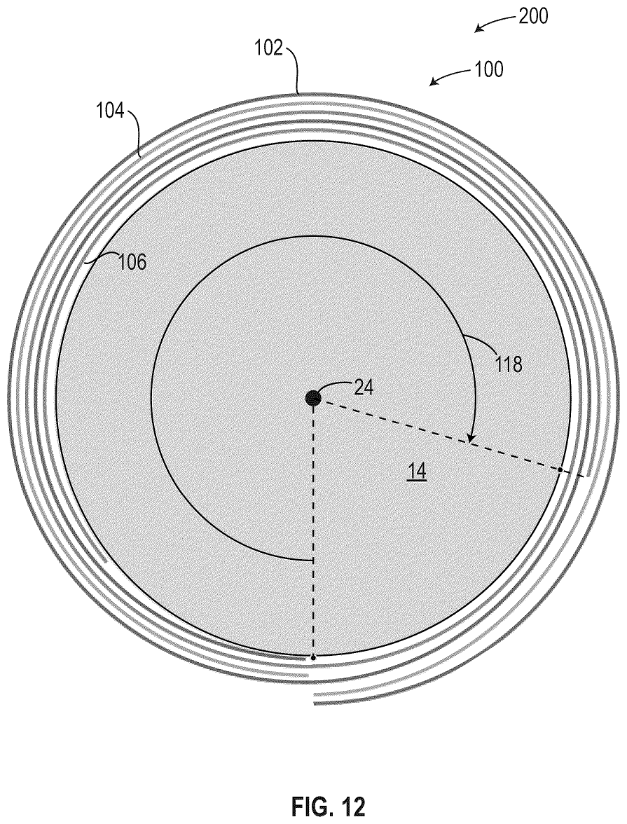

FIG. 12 illustrates a view from the first end 16 of the mandrel 14 after performing the second roll across the second distance 110. When the second roll is performed, an angular portion 118 of the newly rolled layers of materials of the tubular member 200 include the third material 106, the first material 102 and the second material 104, with the second material 104 sandwiched between the third material 106 and the first material 102, and the third material 106 applied over the outer surface of the first material 102. The remaining angular portions of the tubular member 200 across the mandrel 14 include the second material 104 applied to the outer surface of the first material 102, with another layer of the first material 102 applied to the outer surface of the first layer of the second material 104.

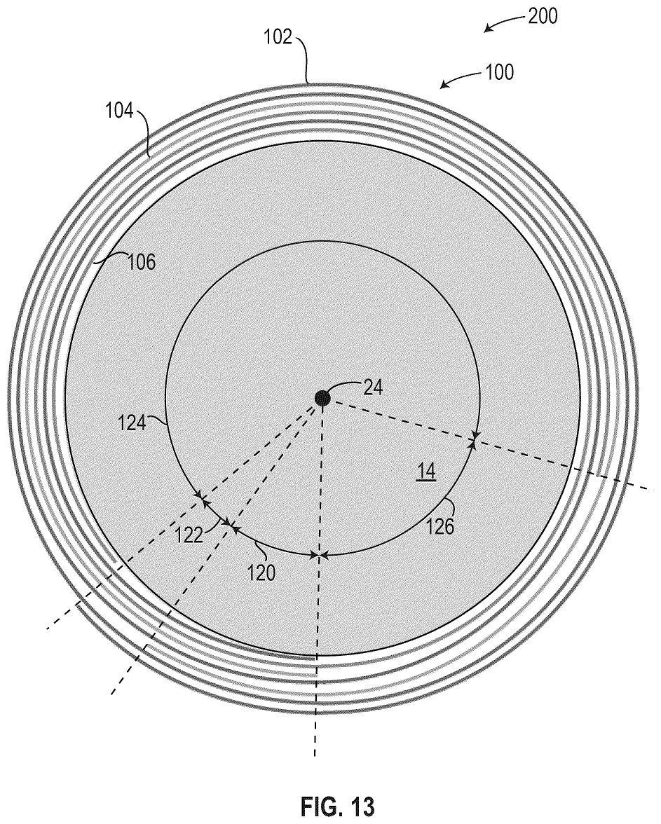

FIG. 13 illustrates a view from the first end 16 of the mandrel 14 after performing the third roll across the third distance 112 and further rolling the mandrel 14 to take up or roll any additional portions of the first material 102 that extend beyond the end of the third distance 112. FIG. 13 illustrates a cross-sectional view of the tubular member 200 at the first end 216 of the tubular member 200, with the rolled materials 100 forming the sidewall of the tubular member 200. The tubular member 200 includes a first angular portion 120 of the sidewall, a second angular portion 122 of the sidewall, a third angular portion 124 of the sidewall, and a fourth angular portion 126 of the sidewall (e.g., all angular portions measured relative to the axis 24 of the tubular member 200 or mandrel 14 which is shown co-axially positioned within the tubular member 200).

The first angular portion 120 includes a stack up of the materials 100, from radially innermost to outermost:
1. a layer of the first material 102;
2. a layer of the third material 106;
3. a layer of the second material 104;
4. a layer of the first material 102;
5. a layer of the second material 104;
6. a layer of the first material 102; and
7. a layer of the first material 102.

The second angular portion 122 includes a stack up of the materials 100, from radially innermost to outermost:
1. a layer of the first material 102;
2. a layer of the third material 106;
3. a layer of the second material 104;
4. a layer of the first material 102;
5. a layer of the first material 102; and
6. a layer of the first material 102.

The third angular portion 124 includes a stack up of the materials 100, from radially innermost to outermost:
1. a layer of the third material 106;
2. a layer of the first material 102;
3. a layer of the third material 106;
4. a layer of the second material 104;
5. a layer of the first material 102; and
6. a layer of the first material 102.

The fourth angular portion 126 includes a stack up of the materials 100, from radially innermost to outermost:
1. a layer of the third material 106;
2. a layer of the first material 102;
3. a layer of the second material 104;
4. a layer of the first material 102; and
5. a layer of the first material 102.

Accordingly, the tubular member 200 that results from rolling the materials 100 includes at least two layers of the first material 102 as the radially outer most layers along an entirety of the tubular member 200. Further, the third material 106 may define the inner surface of the tubular member 200 along certain angular portions, and is sandwiched between the first material 102 and the second material 104 along angular portion 120, angular portion 122, and angular portion 124. In some embodiments, the stack up and rolling as described herein with reference to FIGS. 7-13 results in layers of the third material 106 having an X-weave that extends in a helical pattern along the length of the tubular member 200 while being sandwiched between the first material 102 and the second material 104. In some embodiments, the fibers 132 and the fibers 134 of the third material 106 extend in helical patterns at 45 degrees (e.g., positive and negative 45 degrees) to result in a cross-biased tubular member 200. The fibers 132 and the fibers 134 may also be sandwiched between materials with longitudinally extending fibers (e.g., the material 102 and the material 104) along different portions of the tubular member 200. Advantageously, the tubular member 200 is manufactured using a scrimless stack up of materials with an X-weave or cross-weave carbon fabric that results in a double helical pattern in two directions to improve strength and resilience of the tubular member 200.

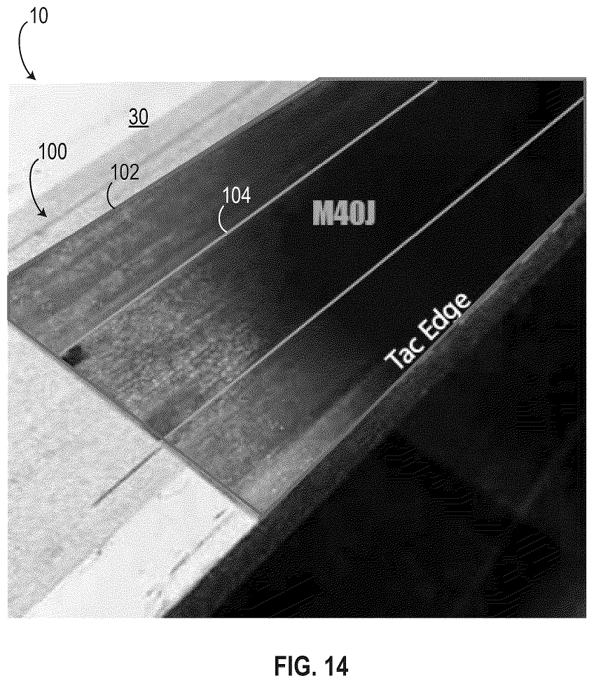

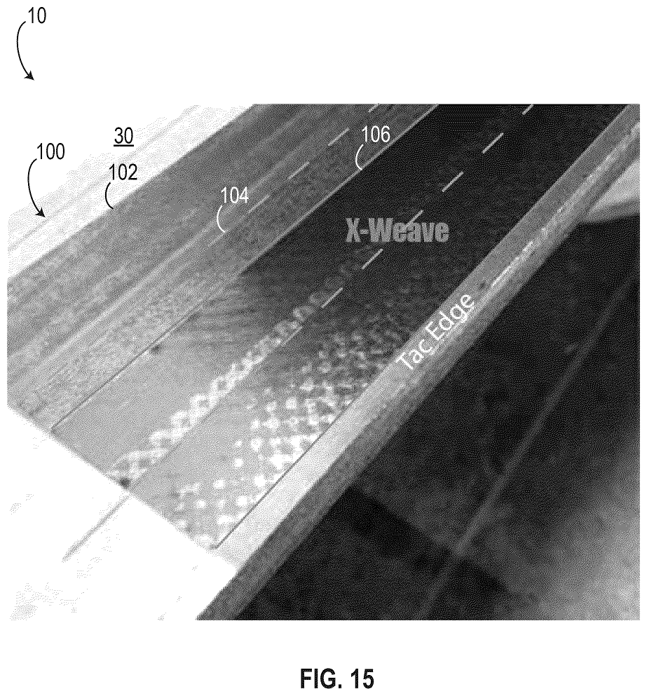

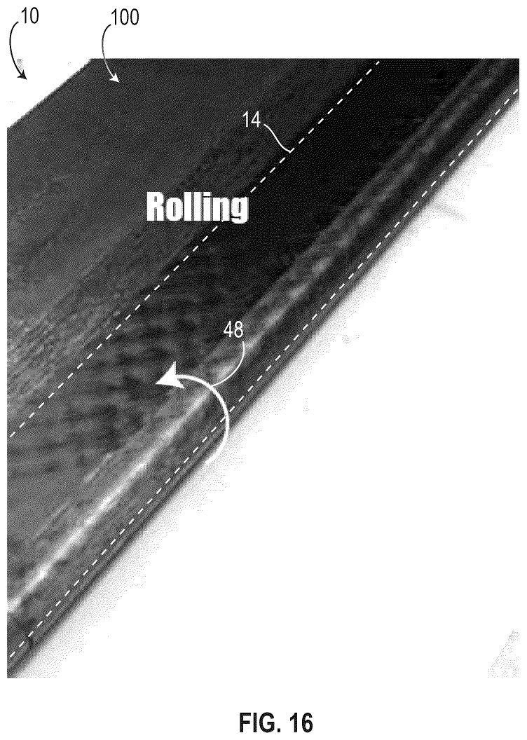

Referring to FIGS. 14-16, the process of laying out the materials 100 according to the stack up shown in and described in greater detail above with reference to FIG. 7 is visually illustrated. FIG. 14 illustrates laying the first material 102 and the second material 104 on the second member 30 (e.g., on the table). An edge of the first material 102 may be aligned with an edge of the second member 30 (e.g., the rolling table). FIG. 15 illustrates laying the third material 106 (e.g., the X-weave material) onto the second material 104 and the first material 102. In some embodiments, the third material 106 is positioned relative to the edge of the second member 30 such that a gap or space is formed. FIG. 16 illustrates rolling the stack of materials 100 with the mandrel 14 in direction 48 in order to produce the tubular member 200.

### Manufacturing Process

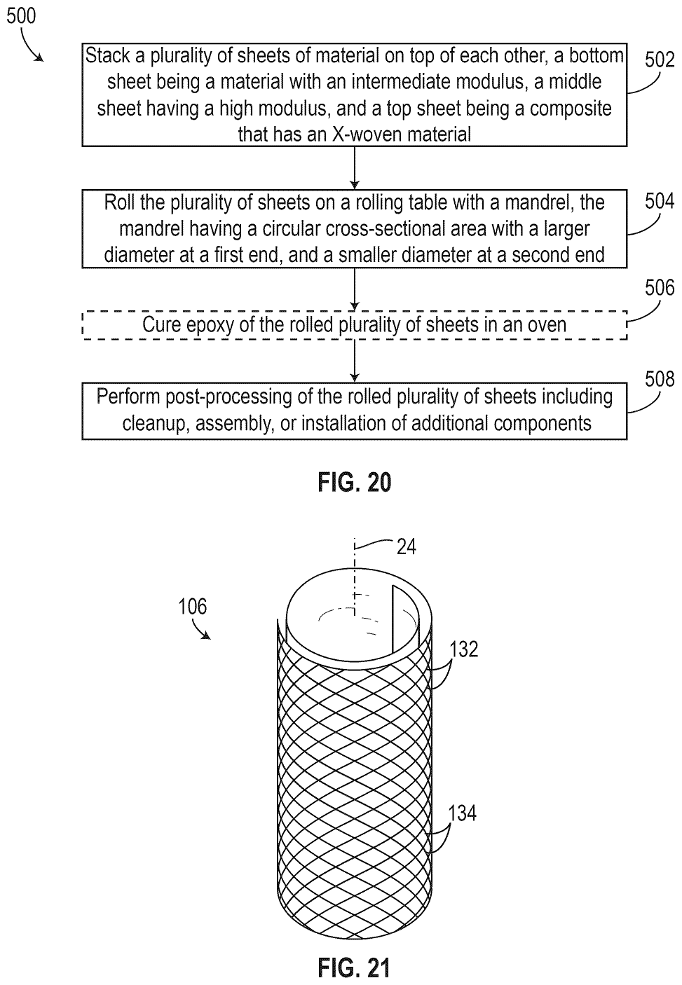

Referring to FIG. 20, a process 500 for manufacturing a tubular member using a rolling technique includes steps 502-508. The process 500 can be performed using composite or carbon fiber materials in order to produce a tubular member that can be used in a variety of applications. In some embodiments, the tubular member is flexible and uses a layer of material that has fibers in an X-weave or a cross-weave which is helically or spirally wound between other materials during the rolling process.

The process 500 includes stacking a plurality of sheets of material on top of each other, a bottom sheet being a material with an intermediate modulus, a middle sheet having a high modulus, and a top sheet being a composite that has an X-woven material (step 502), according to some embodiments. In some embodiments, the middle sheet of material has a higher tensile modulus than the bottom sheet of material. In some embodiments, the middle sheet and the bottom sheet are carbon fiber materials with fibers that extend lengthwise (e.g., longitudinally) along a length of the sheets. In some embodiments, the X-woven material is a composite material that has fibers that are woven or disposed in an X-pattern or a cross-pattern. In some embodiments, the fibers of the X-pattern are offset substantially 45 degrees from the lengthwise direction of the sheets of material. The bottom sheet of material may have a width that extends from a beginning of a first roll, past an end point of a third complete roll of a mandrel. The middle sheet may begin at an end of the first roll and a beginning of a second roll of the mandrel, and terminate at a location past the end of the second roll of the mandrel. The top sheet may initiate before a midpoint of the first roll of the mandrel, and terminate past a midpoint of the second roll of the mandrel, but before the end of the second roll of the mandrel. The bottom sheet of material may have a right trapezoid shape. The middle sheet of material may also have a right trapezoid or trapezoid shape. The top sheet of material may have a right triangle shape. Advantageously, the stack of the plurality of sheets is scrimless which reduces costs, complexity, and labor of performing the process 500.

The process 500 includes rolling the plurality of sheets on a rolling table with a mandrel, the mandrel having a circular cross-sectional area with a larger diameter at a first end, and a smaller diameter at a second end (step 504), according to some embodiments. In some embodiments, the mandrel has a tapered or elongated frustoconical shape. The mandrel may be rolled along the plurality of sheets while applying pressure to the sheets. In some embodiments, the pressure applied to the mandrel while rolling the sheets is non-uniform (e.g., different pressure or force zones along the mandrel) to improve bonding of the sheets as the sheets are rolled. In some embodiments, performing the step 504 results in the production of a tubular member. The tubular member includes the sheet of X-weave material sandwiched in a spiral or helical pattern between the middle sheet and the bottom sheet of materials along various angular portions of the tubular member. The tubular member may be flexible with improved flexural strength due to the X-weave material (e.g., the third material) being sandwiched in a continuous spiral or helical pattern between the middle sheet of material and the bottom sheet of material.

The process 500 includes curing epoxy of the rolled plurality of sheets in an oven (step 506), according to some embodiments. The epoxy may be between the plurality of sheets and facilitates bonding the sheets of the tubular member produced by performing steps 502 and 504. In some embodiments, step 506 is optional. In some embodiments, step 506 is performed by placing the tubular member in an oven, heating the tubular member, and allowing the tubular member to cool.

The process 500 includes performing post-processing of the rolled plurality of sheets (e.g., the tubular member) including cleanup, assembly of additional components (step 508), according to some embodiments. In some embodiments, step 508 includes applying cellophane to the tubular member, installing additional components or interfacing members on the tubular member, or installing the tubular member in an assembly. Step 508 may be optional. In some embodiments, step 508 includes performing a wrapping step using cellophane. In some embodiments, wrapping of the tubular member is performed with controlled tension and speed of the wrap from the first end 216 to the second end 218 of the tubular member 200. Advantageously, wrapping the tubular member 200 may improve straightness of the tubular member, facilitate even resin displacement and wall thickness, and maximize strength and performance of the tubular member 200.

### Configuration of Exemplary Embodiments

As utilized herein with respect to numerical values or numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claim.

1. A method of manufacturing a tubular member, the method comprising:
stacking a plurality of materials on a rolling table, the plurality of materials including one or more bottom layers and an upper layer stacked on top of the one or more bottom layers, the upper layer comprising a fibrous material including (a) a first plurality of fibers that extend in a positive direction relative to a lengthwise direction of the upper layer and (b) a second plurality of fibers that extend in a negative direction relative to the lengthwise direction of the upper layer, the first plurality of fibers and the second plurality of fibers forming an X-pattern; and
rolling the plurality of materials around a mandrel to form the tubular member.

2. The method of claim 1, wherein the one or more bottom layers include a first layer comprising a first material and a second layer comprising a second material, the second layer stacked on top of the first layer, wherein the upper layer is a third layer comprising a third material.

3. The method of claim 2, wherein the first material has a modulus that is less than a modulus of the second material.

4. The method of claim 2, wherein the first material and the second material include fibers that extend in a lengthwise direction of the mandrel and the lengthwise direction of the third material.

5. The method of claim 2, wherein the first layer has a width at an end thereof that is greater than three times a circumference of the mandrel at a butt thereof.

6. The method of claim 2, wherein the second layer has a width at an end thereof that is greater than a circumference of the mandrel at a butt end thereof.

7. The method of claim 6, wherein the width at the end of the second layer is less than twice the circumference of the mandrel at the butt end thereof.

8. The method of claim 2, wherein the second layer is stacked on the first layer and offset from a leading edge of the first layer such that the mandrel completes a first roll before contacting and rolling the second material.

9. The method of claim 2, wherein the third material defines an interior surface along an angular portion of the tubular member at a butt end of the tubular member, and wherein the third material is sandwiched between the first material and the second material at a plurality of angular locations at the butt end of the tubular member.

10. The method of claim 1, wherein the positive direction is a positive 45 degree angle relative to the lengthwise direction of the upper layer, and wherein the negative direction is a negative 45 degree angle relative to the lengthwise direction of the upper layer.

11. The method of claim 10, wherein the first plurality of fibers extend helically along a length of the tubular member at the positive 45 degree angle, and wherein the second plurality of fibers extend helically along the length of the tubular member at the negative 45 degree angle.

12. The method of claim 1, wherein the mandrel has a tapered shape.

13. The method of claim 1, wherein the plurality of materials that are stacked on the rolling table and rolled around the mandrel to produce the tubular member does not include a scrim material.

14. The method of claim 1, further comprising curing the tubular member.

15. A tubular member comprising:
a sidewall including with a plurality of layers comprising a plurality of differing materials, a first material of the plurality of differing materials including (a) a first plurality of fibers that extend helically through the sidewall along a length of the tubular member in a positive direction and (b) a second plurality of fibers that extend helically through the sidewall along the length of the tubular member in a negative direction.

16. The tubular member of claim 15, wherein the positive direction is a positive 45 degree angle relative to the length, and wherein the negative direction is a negative 45 degree angle relative to the length.

17. The tubular member of claim 15, wherein the plurality of differing materials include the first material, a second material, and a third material.

18. The tubular member of claim 17, wherein the second material and the third material include fibers that extend in a lengthwise direction along the length of the tubular member, and wherein the second material has a modulus that is different than a modulus of the third material.

19. The tubular member of claim 17, wherein the first material is provided as a first sheet of the first material, the second material is provided as a second sheet of the second material beneath the first sheet, and the third material is provided as a third sheet of the third material beneath the second sheet, and wherein the first sheet, the second sheet, and the third sheet have different dimensions and shapes.

20. A method of manufacturing a tubular member, the method comprising:
providing a first sheet of a first material, the first sheet having a first shape, the first sheet having a first material property;
providing a second sheet of a second material, the second sheet having a second shape different than the first shape, the second material having a second material property different than the first material property;
providing a third sheet of a third material, the third sheet having a third shape different than the first shape and the second shape, the third material having a third material property different than the first material property and the second material property;
stacking the first sheet, the second sheet, and the third sheet on a rolling table; and
rolling the first sheet, the second sheet, and the third sheet around a mandrel to form the tubular member.
